(19) United States
(12) Patent Application Publication
(10) Pub. No.: US 2018/0061180 A1
(43) Pub. Date: Mar. 1, 2018

(54) System and Method for Incorporating Game Play into Product Transactions

(71) Applicant: Flo, LLC, New York, NY (US)

(72) Inventors: Manu GAMBHIR, Philadelphia, PA (US); Eric J. BLATSTEIN, New York, NY (US); Matt ROSEN, Media, PA (US)

(21) Appl. No.: 15/687,262

(22) Filed: Aug. 25, 2017

Related U.S. Application Data
(60) Provisional application No. 62/380,027, filed on Aug. 26, 2016.

(51) Int. Cl. G07F 17/32; A63F 13/67; G06Q 30/02; G06Q 20/20

(52) U.S. Cl. CPC G07F 17/3244; G07F 17/3286; G07F 17/3295; G06Q 20/20; A63F 13/67; G06Q 30/0238; G07F 17/3218

(57) ABSTRACT

A method for incorporating game play into a transaction for the sale of a product or service using a point-of-sale system. The system includes a tablet computer that accepts an order placed by a patron and offers the patron a chance to play a game to earn a discount off of the purchase price. The system includes at least one computer having a memory and processor. The memory includes gaming software that provides game logic for playing and determining an outcome of the game and a database that stores information including games played and patron's performance. The processor accesses the gaming software, transmits to the tablet information pertaining to the game, and adjusts difficulty of winning the game based on patron's performance. The processor determines an outcome and a discount is applied to the purchase price of the product when the outcome is winning.

### STATEMENT OF RELATED CASE

This case claims priority to U.S. Provisional Patent Application Ser. No. 62/380,027 filed on Aug. 26, 2016 (Attorney Docket 3094-005pr1), which is incorporated herein by reference in its entirety.

### FIELD OF THE INVENTION

The invention relates generally to systems for providing products to customers based on the outcome of a game.

### BACKGROUND OF THE INVENTION

Businesses routinely seek ways to build their brand and to promote and maintain patronage. Traditional ways of doing this include regularly featuring promotional items or discount coupons in print ads (e.g., local newspapers, local mailers, flyers, etc.) and, more recently, over the Internet. Eating and drinking establishments will often include on-premises entertainment, such as musicians, to attract and maintain a customer base. Of late, it is possible for business establishments to transmit coupons (through third party providers) to a person's smart phone when a location service (e.g., GPS, etc.) determines that the phone is near to the business establishment or when there is some indicator that the person might be inclined to patronize the business establishment.

### SUMMARY

The present invention provides an additional way for a business to grow and maintain its customer base. Although generally applicable to any e-commerce transaction for goods or services, hereinafter referred to as a “product.” In the illustrative embodiment, the product is food; that is, the illustrative embodiment pertains to an eating establishment and provides a way for a diner to win, or receive a discount towards, a meal they have ordered.

Embodiments of the invention involve electronic communications and processing, wherein the transaction (sale of goods/services) is conducted via credit card, debit card, or any other payment format (whether or not physically embodied as a card, etc.) that can be electronically processed (hereinafter “e-payment”).

In the illustrative embodiment, the transaction is conducted over the business establishment's order-fulfillment system (e.g., a POS system, etc.) which handles both ordering and payment and is suitably enabled to support the additional functionality disclosed herein. In some embodiments, an i-Pad® or other tablet serves as a user interface for the order-fulfillment system, enabling a patron to order and pay for a meal without the assistance of an employee of the eatery. The additional functionality discussed below (i.e., the method by which a meal, etc., is earned) can be resident on the tablet, as software provided in the form of an App, etc. Alternatively, the tablet can be in communication with a local or non-local (e.g., cloud based, etc) server that executes software that provides the additional functionality.

Before or after the patron's e-payment is entered (e.g., swiped, etc.) into the order-fulfillment system to pay for the meal, but before the payment is processed (in the illustrative embodiment), the patron is given the opportunity to win the meal, or win a discount that can be applied to the purchase of the meal. If the patron wishes to forego this opportunity and simply pay for their meal, they reply appropriately and the transaction is processed at the prevailing pricing. If, however, the patron wishes to win their meal or a discount thereon, they play an electronic game. In some alternative embodiments, the payment is processed before the patron is presented with the opportunity to win the meal or a discount. In such embodiments, the patron is issued a full/partial refund or credit if they win.

The games can be games of chance (e.g., gambling games, sweepstakes, etc.) or skill games. In some embodiments, the patron has no choice as to the type of game that is played. That is, in some embodiments, the system will only offer to all patrons one category of games to play (i.e., games of chance, or gambling games, or sweepstakes, or games of skill). In some other embodiments, the system randomly presents one type of game for a patron to play, which could be a game of chance or a skill game. In some further embodiments, the system selects a type of game based on game-play results (either for the individual or for all patrons playing over a selected period of time).

In some other embodiments, the patron will have the opportunity to select a type of game (chance or skill) but not a particular game within the particular category. In some yet further embodiments, the patron will have an ability to select a particular game of chance, but, as discussed more fully below, they will not have an opportunity to select a particular game of skill.

Gambling format. After placing the order and before or after the patron has entered their e-payment information, they are offered the chance to win their meal by playing a game of chance for a sum of money, such as $1.00. If they decline to play the game, their payment is processed as normal and does not include the cost of the game (in embodiments in which payment processing is deferred).

If the patron elects to play the game, a $1, etc., charge is authorized and the game is played. If the patron wins, the prize may be that their entire order is free or that they receive some percentage discount (e.g., 10% off, 25% off, etc.) off of their order, or receive a fixed dollar amount off of their order, etc. In some embodiments, the charge to play the game is based on the size of the order. For example, a game might cost $1.00 for an order that is $25.00 and cost $2.00 for an order that is $50.00

The odds of winning can be determined, for example, based at least in part, on historical information, such as the average order size. For example, if the average order is $25, and it is expected (or known from historical information) that 100 patrons are likely to choose to play, the odds might be set so that, on average, 1 patron out of 100 patrons that play will win. If it costs a patron a dollar to play, then the owner/operator of the establishment can expect a profit, per 100 plays, of: (1$/play×100 plays)−(1 win×$25/win)=$75.

The final cost of the meal (discounted or free with a win, full price for a loss) is added to the cost of play and then settled on the patron's account. In some alternative embodiments, the cost to play the game is eliminated if the patron wins.

Sweepstakes Format.

After placing the order and before or after the patron has entered their e-payment information, the guest is offered the opportunity to participate in a simple free game of chance. If they decline to play, their card is processed as normal.

If the patron elects to play the game, they are first asked to watch an advertisement from a sponsor or perform some other action beneficial to the owner/operator of the establishment, such as sharing their demographic information, etc. Once they perform the requested action, the patron can play a simple game of chance for free. If they win, the result is the same as in the gambling format. The odds can be based, for example, on the value that the owner/operator receives from the action (e.g., watching the advertisement, etc.) taken by the player.

Skill Format.

Similar to the gambling format, the patron is offered the opportunity to play a simple game of skill for an amount of money, e.g., $1. If the patron chooses to play, in some embodiments, they are offered one of N different simple games of skill (e.g., a memory game, a time-based puzzle, a game involving advanced hand-eye coordination, etc.). If they win, the same process as the gambling format is followed.

There are several approaches for controlling and managing the number of wins. In a first embodiment, the patron is offered one of N skill games for play with no ability to select a particular game. For a subsequent game, the patron is offered a different type of skill game. There are many simple-to-play, but not necessarily simple-to-win skill games that can be selected.

It is unlikely that any one person will be highly proficient at the plural skills required in the various different types of skill games. The (suitably programmed order-fulfillment) system tracks how patrons are performing on particular skill games and particular skills, and adjusts the difficulty of winning through the choice of game until a desired payout rate is reached. In the illustrated embodiment, the level of difficulty of winning the game is adjusted in subsequent games offered to subsequent players. As such, the current game will never become more difficult mid-game, but rather, a new game may have a greater level of difficulty. Therefore, if a player is very good at a particular type of skill, such as memory for example, the next game offered for play is likely to require a different skill mechanic. In additional embodiments, other methods or processes may adjust the level of difficulty of winning, which will be clear to those skilled in the art.

In a second embodiment, there are plural difficulty levels (adjusted by controlling game parameters) and as players win games in a relevant time period (e.g., over the course of 4 hours, over the course of a day, etc.), the difficulty level presented for game play increases, thus reducing the number of wins. The system indicates the difficulty level to the patron prior to game play.

In a third embodiment, there is a rolling hurdle to a win, whereby every player must complete game play by besting the highest score of the previous predetermined number of games played. In the illustrative embodiment, the highest score of the previous 100 games played is used.

An embodiment of the present invention is a point-of-sale system for incorporating game play into a transaction for the sale of a product, the system comprising, at least one interactive device that accepts, as input, a product order placed by a patron and by which the patron is able to play a game to earn a discount on a purchase price of the product, at least one computer, wherein the computer includes a memory, wherein the memory includes, gaming software that provides game logic for playing and determining an outcome of the game, and a game history database that provides a record of games played and performance by the patron, a processor, wherein the processor, accesses the gaming software and transmits, to the tablet computer, first information pertaining to the game, receives second information pertaining to the game from the tablet computer, determines whether an outcome of the game is a winning outcome, and applies a discount to the purchase price of the product if the outcome is winning.

Another embodiment of the present invention is a computer-implemented method for incorporating game play into a transaction for the sale of a product, the method comprising using at least one data processing system and at least one database for performing the following, transmitting, from the data processing system to a tablet computer, a query to play a game on the tablet computer, adjusting, by the data processing system, a difficulty of winning the game by requesting historical information, from the database, pertaining to a user, receiving, at the data processing system, information pertaining to the game from the tablet computer, determining whether an outcome of the game is winning, and automatically applying, by the data processing system, a discount to a purchase price of the product, when the outcome of the game is winning.

Yet another embodiment of the present invention is a non-transitory computer-readable medium with computer-executable instructions stored thereon that, when executed by a processor of a point-of-sale system, cause the processor to perform operations comprising, transmitting to a tablet computer associated with a first patron, a query to play a game within a graphical user interface on the tablet computer, adjusting a difficulty of winning the game by requesting historical information from the storage medium pertaining to the first patron, receiving information pertaining to the game from the tablet computer, determining whether an outcome of the game is winning, and applying a discount to a purchase price of the product when the outcome of the game is winning.

### BRIEF DESCRIPTION OF THE DRAWINGS

FIG. 1 depicts a restaurant incorporating a POS system in accordance with the illustrative embodiment of the invention.

FIG. 2 depicts an embodiment of the POS system in accordance with the illustrative embodiment.

FIG. 3 depicts an architecture of a computer used in the POS system of FIG. 2.

FIG. 4 depicts relevant databases and software modules in the memory of the computer of FIG. 3.

FIG. 5 depicts a flow chart of the operation of the POS system in accordance with an embodiment of the invention.

### DETAILED DESCRIPTION

The present invention is directed to a system and method for incorporating game play into product transactions. Although a restaurant is a preferred business environment for using embodiments of the invention, it is to be understood that embodiments of the invention can be used in any business environment that solicits transactions from consumers and/or shoppers. For example, the system is applicable to any business establishment including but not limited to retail stores, wholesale establishments, theme parks, sports stadiums, theaters, service providers, and any other business establishment, which serves customers by providing goods, services, or entertainment. In such embodiments, the system, which may be in the form of any interactive device, is preferably at or near the establishment (i.e. at the entrance to a ride in an amusement park, entrance to a movie theater, near the ticket counter in an airport/train station, etc.).

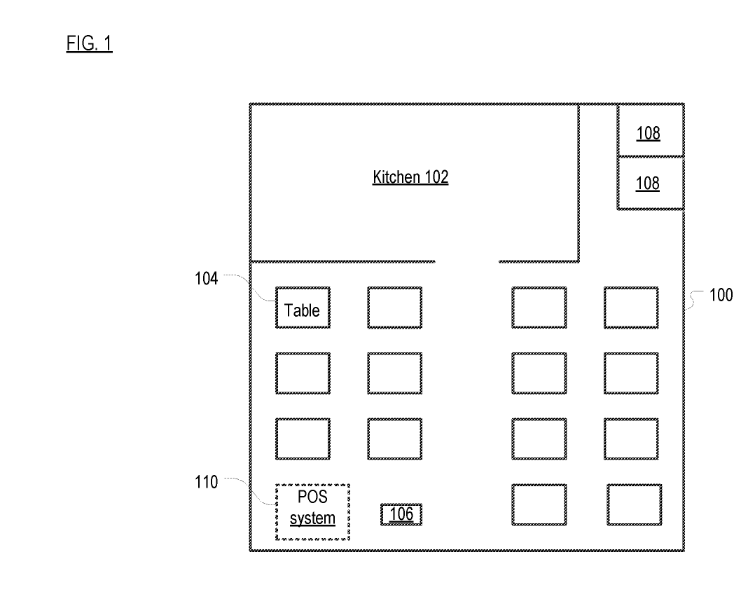

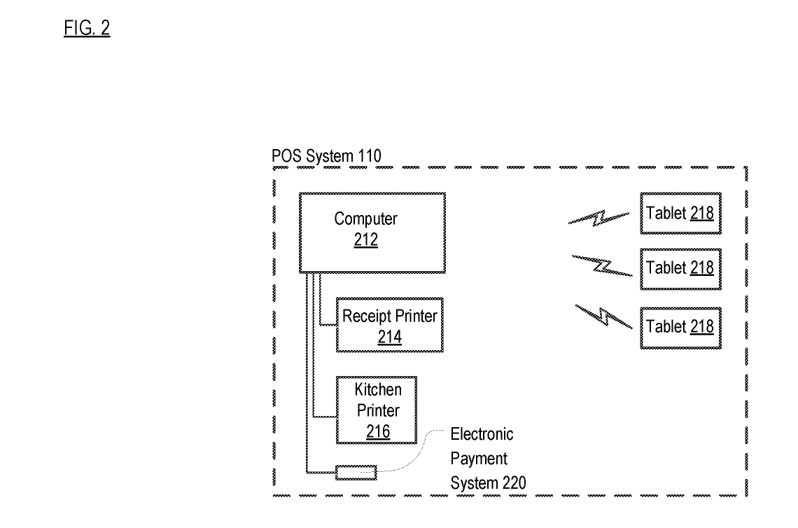

FIG. 1 depicts restaurant 100. Restaurant includes kitchen 102, tables 104, reception/payment station 106, bathrooms 108, and POS system 110. As discussed in conjunction with FIG. 2, POS system 110 includes a variety of elements distributed throughout restaurant 100.

FIG. 2 depicts POS system 110 in accordance with the illustrative embodiment of the invention. The POS system includes computer 212, receipt printer 214, kitchen printer 216, a plurality of tablets 218, and an electronic payment system 220. The system is deployed on computer 212, or set of computers, working together to implement specific business functionality. In other embodiments, the system may stand-alone without the need for a receipt printer or kitchen printer. It will be appreciated by those skilled in the art that in some embodiments, other system architectures, including a server-less architecture, may be provided for supporting the system and method of the present invention.

Computer 212 is in communication with all elements of the system. In the illustrative embodiment, printers 214 and 216 and electronic payment system 220 (e.g., credit card swipe, credit card chip readers [EMV], pay-by-phone/watch systems, etc.) communicate with computer 212 via Ethernet while tablets 218 communicate wirelessly (e.g., WiFi, etc.) with the computer. In some embodiments, electronic payment system 220 is incorporated into tablet 218; in such embodiments, the electronic payment system communicates wirelessly, or by any other suitable means, with computer 212. It will be appreciated by those skilled in the art that in other embodiments, other communications protocols, including all other available methods, for supporting communications between various elements of POS system 210, may suitably be used.

Interactive devices 218, which may be a conventional tablet computer, such as an Apple iPad®, Samsung Galaxy®, Google Nexus®, etc., is appropriately configured (software, etc.) for inputting a food order. It will be appreciated by those skilled in the art that in other embodiments, the interactive device may be any interactive device for inputting an order (e.g., Alexa®, patron's own smartphone, surface computer, Echo®, etc.). In the illustrative embodiment, the order is input by the patrons. The order is transmitted, preferably wirelessly but may be by any other suitable means, to computer 212, which, in turn, transmits the order to kitchen printer 216. The order is printed out via printer 216 for the kitchen staff. In some embodiments, electronic payment system 220 is incorporated with tablets 218. In yet some other embodiments, printer 216 may be an electronic display device, tablet computer with screen, or other suitable means for electronically displaying the order for viewing by the kitchen staff.

Tablets 218 are also used by a patron to play the games. It will be appreciated by those skilled in the art that in other embodiments, even when interactive devices or tablets are present, the games may be played on other interactive devices (e.g., the patron's own smartphone, laptop, tablet, etc.). In addition, the games may be played at any time. To play a game, a patron either responds to a query (inquiring whether the patron wishes to play) or the patron “clicks” on a game icon. In either case, a software application is accessed that generates an appropriate graphical user interface (“GUI”) for the game and causes it to be displayed in the display screen of tablet 218. The GUI, unique for each game, presents to the patron the game's environment and is also the means by which the patron interacts with the game, such as via soft keys. The GUI also displays the results of the patron's actions. In the illustrative embodiment, the software application is resident on tablet 218. However, in some other embodiments, the software application responsible for generating the GUI can be resident on computer 212 or be cloud based. It will be appreciated by those skilled in the art that in other embodiments, a GUI is not necessary for supporting the system and method of the present invention.

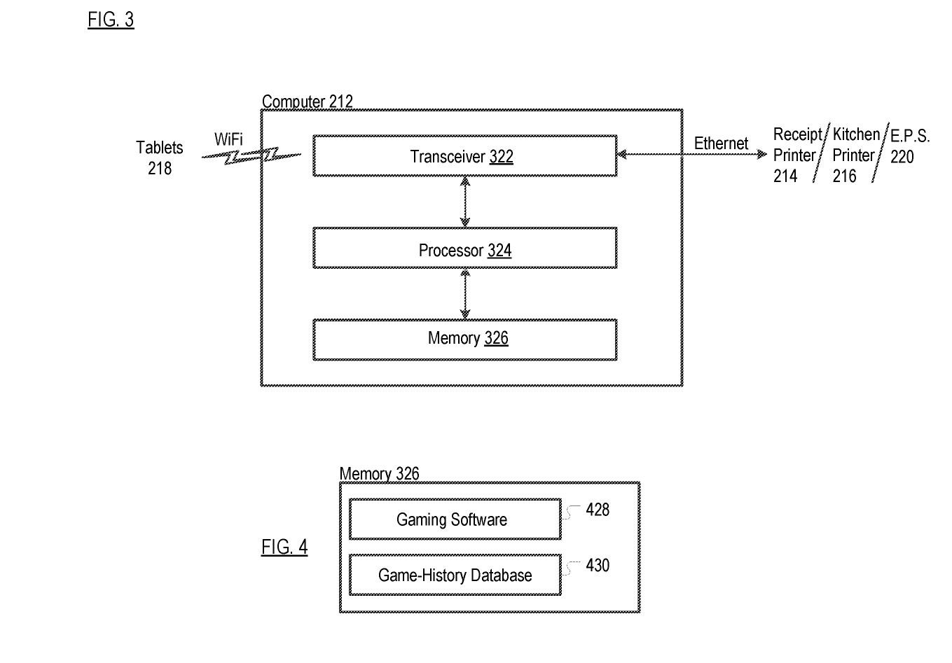

FIG. 3 depicts further detail of computer 212. The computer includes transceiver 322, processor 324, and memory 326. In some alternative embodiments, much or all of the functionality provided by computer 212 can be provided by a cloud-based system. However, for pedagogical purposes, the invention will be presented in the context of a system using local computer 212.

Transceiver 322 enables computer 212 to communicate with the other devices via one or more communications protocols (e.g., Blue-tooth, WiFi, cellular, Ethernet, etc.). It will be clear to those skilled in the art, after reading this specification, how to make and use transceiver 322.

Processor 324 is a general-purpose processor that is capable of, among other tasks, executing an operating system, executing specialized application software used in conjunction with the embodiments of the invention, and populating, updating, using, and managing data in memory 326. In some alternative embodiments of the present invention, processor 324 is a special-purpose processor. It will be clear to those skilled in the art how to make and use processor 324.

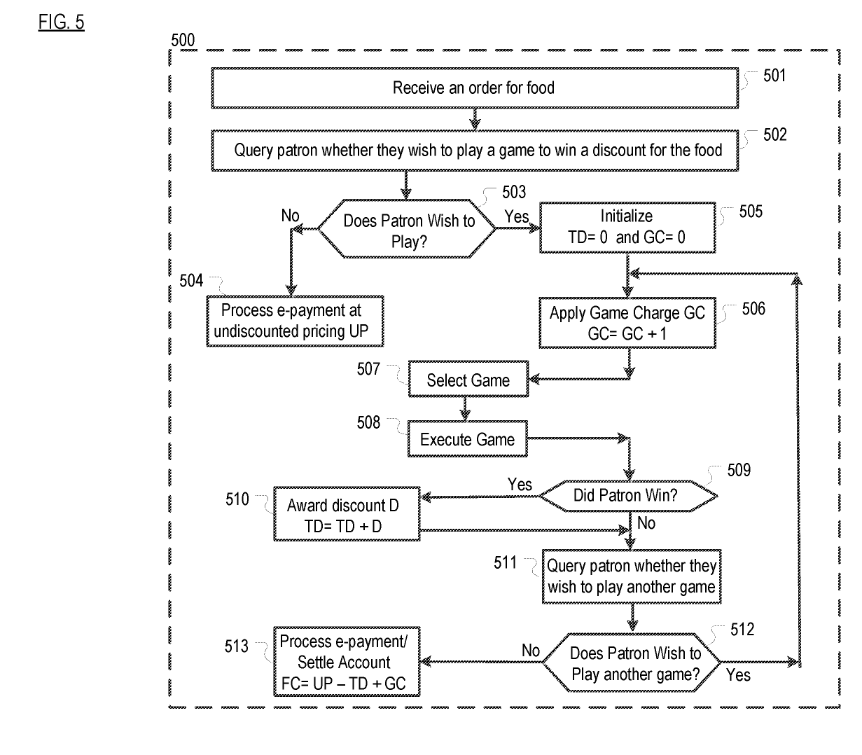

Memory 326 is a non-volatile, non-transitory memory technology (e.g., RAM, ROM, EPROM, EEPROM, hard drive(s), flash drive(s) or other solid state memory technology, CD-ROM, DVD, etc.) that stores, among any other software and data, specialized application software, such as discussed in conjunction with FIGS. 4 and 5, which, when executed, enable processor 324 to perform the features and tasks of the various embodiments of the invention. It will be clear to those skilled in the art how to make and use memory 326.

The term “non-transitory” is to be understood to remove only propagating transitory signals per se from claim scope and does not relinquish rights to all standard computer-readable media that are not only propagating transitory signals per se.

FIG. 4 depicts some of the contents of memory 326; in particular, specialized application software, such as gaming software 428, and databases, such as game-history database 430. It will be appreciated by those skilled in the art that in other embodiments, the memory may be random access memory (RAM). In other embodiments, the game does not have to be fully stored in memory, for example, the game could be stored on hard drive and only relevant portions in memory, or the game could also be in a distributed processing environment where there are multiple “memory” systems.

Gaming software 428 includes game logic for playing and determining outcomes for at least some of the various games offered for play. Gaming software 428 provides logic, etc., for running games in one or more of any of four legal categories of gaming: sweepstakes, gambling, loyalty, and skill. However, it will be appreciated that other embodiments are by no means limited to these categories of gaming, and that the general system and method is applicable to a wide range of gaming activities in a far broader context. In some other embodiments and for some games, the game logic is provided by the software application resident on tablet 218. It will be appreciated by those skilled in the art that in other embodiments, various parts of the game software may be provided in various locations, including on different hardware or cloud-based systems, for example, parts of the game software may be provided on the tablet, while parts on the computer and yet other parts on other computers.

In some alternative embodiments, POS 110 includes a separate gaming server (not depicted) that runs all of the games made available for play. The gaming server runs software that provides the game-play logic and determines outcomes, in response to player input, as submitted via tablet 218 (typically running client-side game software that generates the GUI).

To the extent a patron plays at least one game (see, e.g., FIG. 5 and accompanying discussion), the patron's game history (e.g., games played, performance, etc.) is tracked and stored in game history database 430. In some embodiments, the game history database 430 includes historical information that may include user identification information, game-play history, game-play performance, length of time of game-play, type of game, results information, winnings information, and user account information. In other embodiments, the game history may not be saved.

FIG. 5 depicts method 500 for incorporating game play into a POS system in accordance with an embodiment of the invention. In task 501, POS system 110 receives an order for food, as input by a patron. At task 502, the patron is queried as to whether they wish to play a game to win a discount on their food order. POS system 110 receives the patron's response and determines, at task 503, whether the patron wishes to play. If not, then the e-payment for the undiscounted price for the food is processed and settled at task 504. As indicated earlier, in other embodiments, e-payment is settled before the option to play a game is presented.

If the patron wishes to play a game, then at task 505, initialize total discount (TD)=0 and game charge (GC)=0. At task 506, game charge GC is applied/authorized as GC=GC+1. It should be noted that the GC might be different for each game played. This expression enables game charges to be accumulated if the patron plays more than 1 game. At task 507, as discussed in further detail later in this specification, in some situations, the patron is permitted to select the game; in others, POS 110 selects the game.

The game is played at task 508. Query, at task 509, whether the patron won. If so, award discount D, wherein total discount TD=TD+D at task 510. It should be noted that the D might be different for each game played. This expression enables discounts to be accumulated if the patron plays more than 1 game. Then proceed to task 511. If the game outcome is that the patron lost, proceed to task 511.

At task 511, system determines whether to continue offering the patron the option to play more games or not. In other embodiments, the patron may be queried as to whether they wish to play another game. POS system receives the patron's response and determines, at task 512, whether the patron wishes to play another game.

If the patron does not wish to play another game, then their account is settled (e-payment is processed) at task 513 wherein final charge FC=undiscounted pricing UP−total discount TD+game charge GC. If the patron chooses to play another game, processing loops back to task 506 wherein another game charge is applied and the processing proceeds as previously described. In some embodiments, if the patron wins the game, the game charge is waived.

As previously indicated, in some scenarios, the game is selected at task 507 by the patron and in others it is selected by the system. More particularly, in some embodiments, patrons are not free, at least following a first selection, to select from among different skill games supported by POS 110.

The reason is that it is possible that a patron will be particularly adept at a particular skill, which will give that individual a significant advantage when playing games based on such a skill. Consequently, in some embodiments in which a patron is able to select, for an initial play, a particular skill game, all subsequent selections will be made via POS system 110. In particular, for a subsequent game, the system will select games based on a different skill.

POS system 110 can track a patron's performance over time, either during a single session or over the course of multiple visits to the restaurant. Performance is stored in game-history database 430. The POS system can achieve a desire payout rate by either via game selection or by adjusting the difficulty of the game by controlling certain game parameters. For example, if the player is particularly good at memory games, POS system 110 may present skill games that do not test a patron's memory, or, alternatively, may present a skill game based on a memory mechanic, but make the memory task relatively more challenging.

Other approaches to controlling and managing wins of skill format games, as described in the Summary section, may suitably be used.

In another embodiment, the system and method provided may be used in a retail establishment. In the case of a retailer, interactive devices may be tablets located throughout the store at various locations (e.g., a few in every aisle) for supporting the system and method of the present invention.

In yet another embodiment, the system and method provided may be used in a theme park. In the case of a theme park, interactive devices may be tablets located at the entrance of the park or particular rides. Alternatively, consumers may use their own smartphones to play a game play in order to receive a discount off of parking, admission to the park, admission to an attraction, food, drink, or rides.

In yet another embodiment, the system and method provided may be used in a service environment. In the case of a service environment, interactive devices may be used to place an order for a service. A variety of services may be provided, including but not limited to, personal care, automotive care, lawn care, maintenance, building, repair, or cleaning. In the present example, the service may be ordered from the consumer's home or office using intelligent voice control, for example, via Amazon Alexa®. In such embodiment, the consumer verbally places an order for a service by speaking to Alexa®, and the system may offer game play in order to receive a discount off of the service.

It is to be understood that the disclosure describes a few embodiments and that many variations of the invention can easily be devised by those skilled in the art after reading this disclosure and that the scope of the present invention is to be determined by the following claims.

What is claimed:

1. A point-of-sale system for incorporating game play into a transaction for the sale of a product, the system comprising:
at least one interactive device that accepts, as input, a product order placed by a patron and by which the patron is able to play a game to earn a discount on a purchase price of the product;
at least one computer, wherein the computer includes:
(a) a memory, wherein the memory includes:
(i) gaming software that provides game logic for playing and determining an outcome of the game, and
(ii) a game history database that provides a record of games played and performance by the patron;
(b) a processor, wherein the processor:
(i) accesses the gaming software and transmits, to the tablet computer, first information pertaining to the game;
(ii) receives second information pertaining to the game from the tablet computer;
(iii) determines whether an outcome of the game is a winning outcome; and
(iv) applies a discount to the purchase price of the product if the outcome is winning.

2. The system of claim 1 wherein the game is a game of skill, and the processor selects the game of skill that the patron plays.

3. The system of claim 2 wherein the processor selects the game of skill based on information pertaining to the patron's performance on games contained in the game history database.

4. The system of claim 2 wherein the processor adjusts a level of difficulty of game play based on a number of wins in a period of time.

5. The system of claim 3 wherein for a winning outcome, the patron's performance for the game must exceed the performance of the previous predetermined number of games played.

6. A computer-implemented method for incorporating game play into a transaction for the sale of a product, the method comprising using at least one data processing system and at least one database for performing the following:
transmitting, from the data processing system to a tablet computer, a query to play a game on the tablet computer;
adjusting, by the data processing system, a difficulty of winning the game by requesting historical information, from the database, pertaining to a user;
receiving, at the data processing system, information pertaining to the game from the tablet computer;
determining whether an outcome of the game is winning, and
automatically applying, by the data processing system, a discount to a purchase price of the product, when the outcome of the game is winning.

7. The method of claim 6 wherein the historical information includes one or more selected from the group consisting of user identification information, game-play history, game-play performance, length of time of game-play, type of game, results information, winnings information, and user account information.

8. The method of claim 7 wherein the historical information comprises the number of wins in a period of time.

9. The method of claim 7 wherein game-play performance is determined by comparing the historical information to predetermined performance criteria.

10. The method of claim 9 wherein the game-play performance information indicates a level of play for the user.

11. The method of claim 10 wherein adjusting the difficulty of winning the game comprises altering game parameters based on the level of play of the user.

12. The method of claim 9 wherein adjusting the difficulty of winning the game comprises selecting the game to be played on the tablet computer based on the user's game-play performance.

13. The method of claim 7 wherein determining an outcome of the game comprises determining if the user's game-play performance exceeds the performance of the previous predetermined number of games played.

14. A non-transitory computer-readable medium with computer-executable instructions stored thereon that, when executed by a processor of a point-of-sale system, cause the processor to perform operations comprising:
transmitting to a tablet computer associated with a first patron, a query to play a game within a graphical user interface on the tablet computer;
adjusting a difficulty of winning the game by requesting historical information from the storage medium pertaining to the first patron;
receiving information pertaining to the game from the tablet computer;
determining whether an outcome of the game is winning, and
applying a discount to a purchase price of the product when the outcome of the game is winning.

15. The non-transitory computer-readable medium of claim 14 wherein the historical information includes one or more selected from the group consisting of patron identification information, game-play history, game-play performance, length of time of game-play, type of game, results information, winnings information, and patron account information.

16. The non-transitory computer-readable medium of claim 15 wherein the processor selects the game based on the historical information contained in the storage medium pertaining to the patron's game-play performance.

17. The non-transitory computer-readable of claim 16 wherein the game-play performance information indicates a level of play for the user.

18. The non-transitory computer-readable of claim 17 wherein adjusting the difficulty of winning the game comprises altering game parameters based on the level of play of the user.

19. The non-transitory computer-readable medium of claim 17 wherein the processor adjusts a level of difficulty of game-play based on a number of wins in a period of time.

20. The non-transitory computer-readable medium of claim 15 wherein for a winning outcome, the patron's game-play performance must exceed the performance of the previous predetermined number of games played.
